(19) United States
(12) Patent Application Publication
(10) Pub. No.: US 2025/0079761 A1
(43) Pub. Date: Mar. 6, 2025

(54) Connector and Connector Assembly

(71) Applicants: SIBAS Electronics (Xiamen) Co. Ltd., Xiamen City (CN); Tyco Electronics (Shanghai) Co., Ltd., Shanghai (CN)

(72) Inventors: Yingchun (David) Wang, Shanghai (CN); Xiangshui Su, Xiamen (CN); Yong (Chris) Wang, Shanghai (CN); Liqiang (Gino) Yao, Shanghai (CN); Qiang Yuan, Xiamen (CN); Aibing (Alan) Dong, Shanghai (CN); Hua He, Shanghai (CN)

(73) Assignees: SIBAS Electronics (Xiamen) Co. Ltd., Xiamen City (CN); Tyco Electronics (Shanghai) Co., Ltd., Shanghai (CN)

(21) Appl. No.: 18/815,931

(22) Filed: Aug. 27, 2024

(30) Foreign Application Priority Data
Aug. 31, 2023 (CN) 202311120197.8

(51) Int. Cl. H01R 13/629

(52) U.S. Cl. CPC H01R 13/62933

(57) ABSTRACT

A connector includes a housing and a locking member rotatably connected to the housing. The locking member is rotatable between a locking position and an unlocking position. The locking member includes a pair of force arms, a pair of hook shaped locking parts, and a pair of rollers. First ends of the pair of force arms are rotatably connected to an outer side of the housing. The pair of hook shaped locking parts are respectively formed on second ends of the pair of force arms. The pair of rollers are rotatably installed on the ends of the hook shaped locking parts. As the hook shaped locking part is locked onto the locking post, the roller of the hook shaped locking part is in rolling contact with the locking post.

### CROSS-REFERENCE TO RELATED APPLICATION

This application claims the benefit of Chinese Patent Application No. CN202311120197.8 filed on Aug. 31, 2023 in the State Intellectual Property Office of China, the whole disclosure of which is incorporated herein by reference.

### FIELD OF THE DISCLOSURE

The present disclosure relates to a connector and a connector assembly comprising the connector.

### BACKGROUND

In the prior art, a heavy-duty connector includes locking member rotatably provided on a housing. The locking member has a hook shaped locking part. A locking post is fixedly installed on a mating housing of a mating heavy-duty connector. The locking member can be rotated between the locking and unlocking positions. When the locking member is rotated to the locking position, the hook shaped locking part on the locking member is locked onto the locking post of the mating housing to lock the housing of the heavy-duty connector and the mating housing of the mating heavy-duty connector together. When the locking member is rotated to the unlocking position, the hook shaped locking part on the locking member separates from the locking post on the mating housing. In the prior art, during the process of locking the hook shaped locking part to the locking post, the end of the hook shaped locking part slides against the locking post. This causes severe wear between the hook shaped locking part and the locking post, and reduces the service life of the locking member and the locking post. In the prior art, when the hook shaped locking part and the locking post are locked multiple times, the locking function will be lost due to severe wear, resulting in the inability of the heavy-duty connector and the mating heavy-duty connector to be securely locked together.

### SUMMARY

According to an embodiment of the present disclosure, a connector includes a housing and a locking member rotatably connected to the housing. The locking member is rotatable between a locking position engaged with a mating housing and an unlocking position separated from the mating housing. The locking member includes a pair of force arms, a pair of hook shaped locking parts and a pair of rollers. First ends of the pair of force arms are rotatably connected to an outer side of the housing. The pair of hook shaped locking parts respectively formed on second ends of the pair of force arms. As the locking member is rotated to the locking position, the hook shaped locking part of the locking member is locked onto a locking post of the mating housing to lock the housing and the mating housing together. The pair of rollers are rotatably installed on the ends of the hook shaped locking parts, respectively. As the hook shaped locking part is locked onto the locking post, the roller of the hook shaped locking part is in rolling contact with the locking post.

### BRIEF DESCRIPTION OF THE DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a connector assembly according to an exemplary embodiment of the present invention;

FIG. 2 shows an illustrative perspective view of a connector according to an exemplary embodiment of the present invention;

FIG. 3 shows an illustrative perspective view of a locking member of a connector according to an exemplary embodiment of the present invention;

FIG. 4 shows an illustrative plan view of a connector assembly according to an exemplary embodiment of the present invention, wherein the locking member is in the unlocked position;

FIG. 5 shows an illustrative plan view of a connector assembly according to an exemplary embodiment of the present invention, wherein the process of locking the locking member to the locking post is shown;

FIG. 6 shows an illustrative plan view of a connector assembly according to an exemplary embodiment of the present invention, wherein the locking member is in the locking position;

FIG. 7 shows an illustrative perspective view of a connector assembly according to another exemplary embodiment of the present invention;

FIG. 8 shows an illustrative perspective view of a connector according to another exemplary embodiment of the present invention; and

FIG. 9 shows an illustrative perspective view of a locking member of a connector according to another exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According an embodiment of the present disclosure, a connector comprises a housing, and a locking member which is rotatably connected to the housing. The locking member is rotatable between a locking position engaged with a mating housing and an unlocking position separated from the mating housing. The locking member comprises: 1) a pair of force arms, one ends of which are rotatably connected to the outer side of the housing; 2) a pair of hook shaped locking parts respectively formed on the other ends of the pair of force arms; and 3) a pair of rollers rotatably installed on the ends of the hook shaped locking parts, respectively. When the locking member is rotated to the locking position, the hook shaped locking part of the locking member is locked onto a locking post of the mating housing to lock the housing and the mating housing together. During the process of locking the hook shaped locking part onto the locking post, the roller of the hook shaped locking part is in rolling contact with the locking post to reduce friction between the two.

According to another aspect of the present disclosure, a connector assembly includes the above described connector and a mating connector mated with the connector. The mating connector comprises a mating housing for mating with the housing of the connector, and a locking post fixedly on the outer side of the mating housing. The hook shaped locking part of the locking member of the connector is locked onto the locking post of the mating housing, so as to lock the connector and the mating connector in a mating state. During the process of locking the hook shaped locking part onto the locking post, the roller on the hook shaped locking part is in rolling contact with the locking post to reduce friction between the two.

### First Embodiment

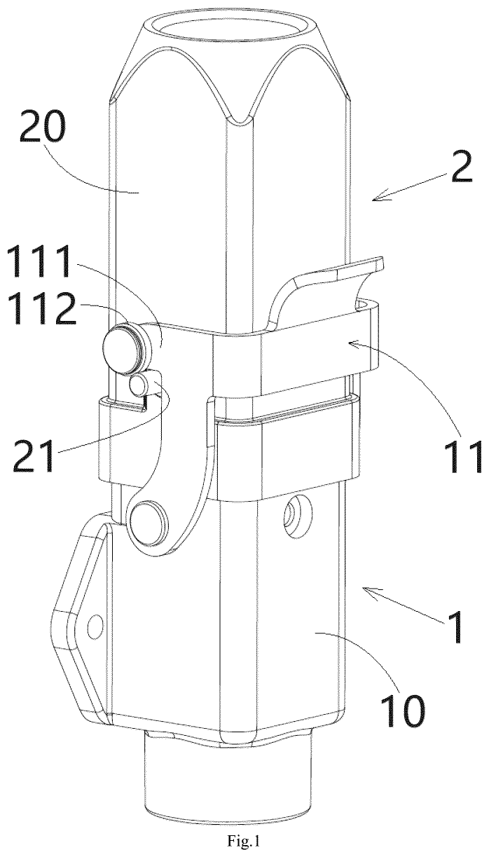

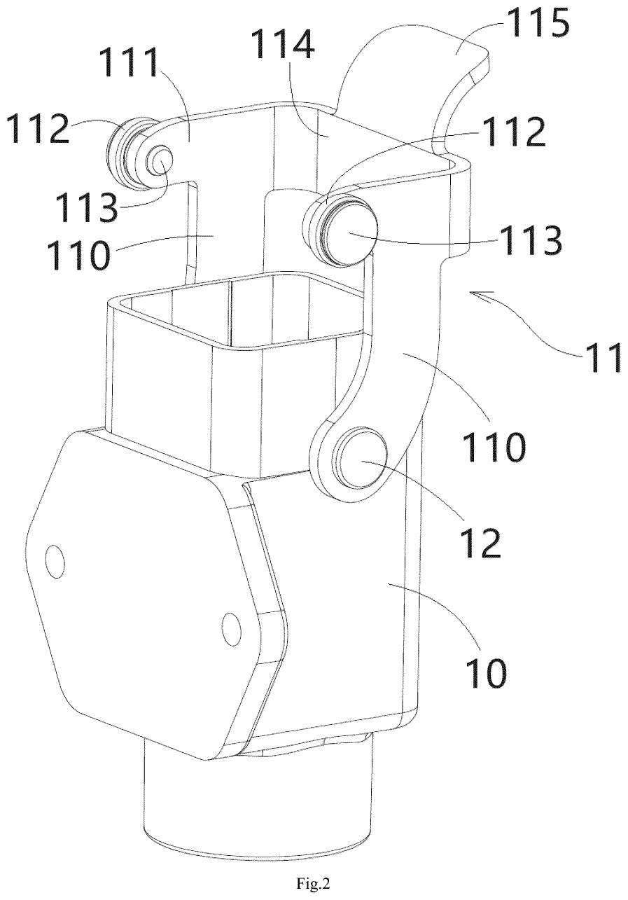

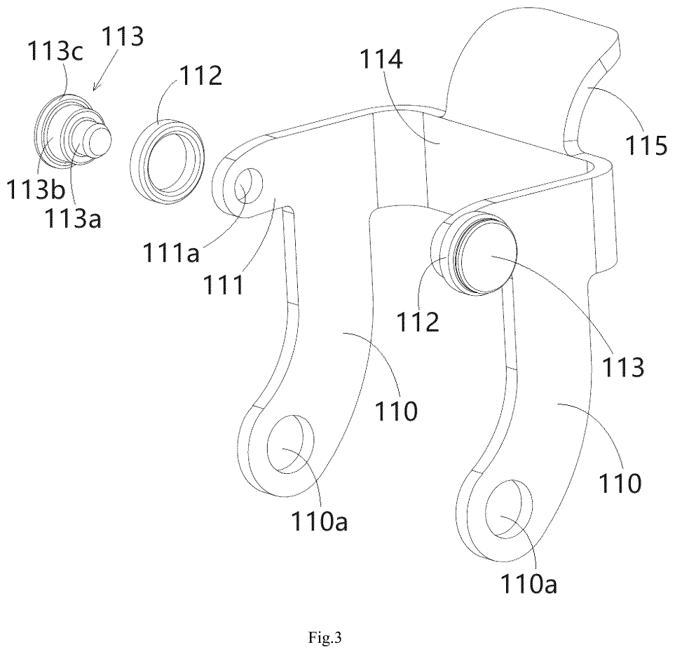

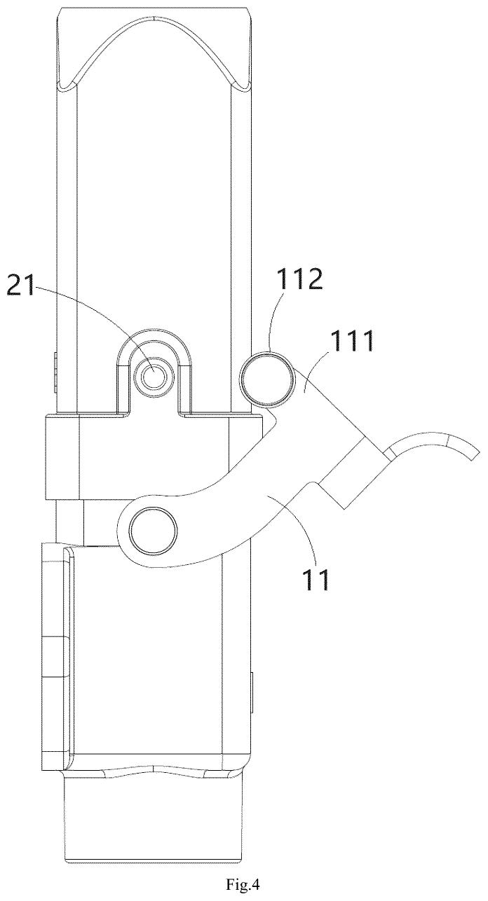

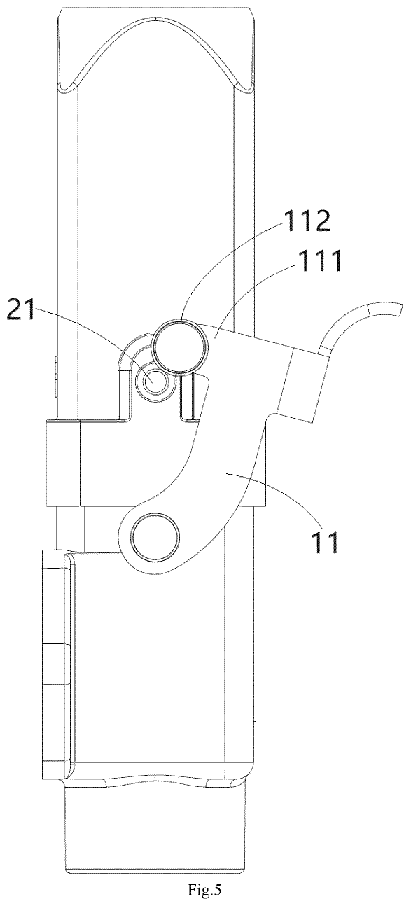

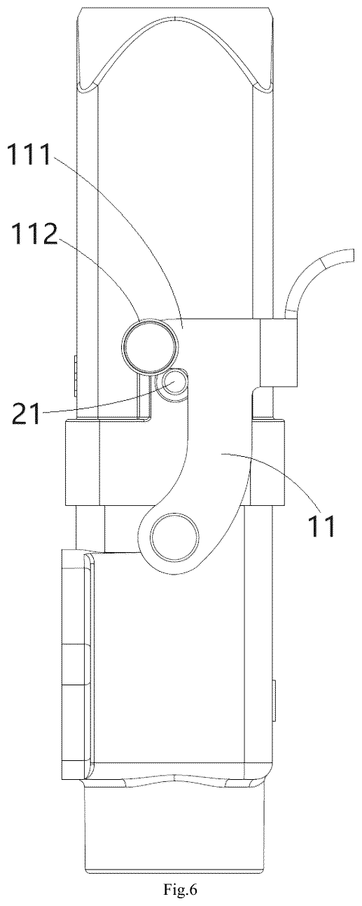

FIGS. 1-6 show connectors and connector assembly according to the first embodiment of the present disclosure. Among them, FIG. 1 shows an illustrative perspective view of a connector assembly according to an exemplary embodiment of the present disclosure. FIG. 2 shows an illustrative perspective view of a connector according to an exemplary embodiment of the present disclosure. FIG. 3 shows an illustrative perspective view of a locking member of the connector according to an exemplary embodiment of the present disclosure. FIG. 4 shows an illustrative plan view of a connector assembly according to an exemplary embodiment of the present disclosure, wherein the locking member is in the unlocked position. FIG. 5 shows an illustrative plan view of a connector assembly according to an exemplary embodiment of the present disclosure, wherein the process of locking the locking member to a locking post is shown. FIG. 6 shows an illustrative plan view of a connector assembly according to an exemplary embodiment of the present disclosure, wherein the locking member is in the locking position.

As shown in FIGS. 1-6, in an exemplary embodiment of the present disclosure a connector 1 is disclosed. The connector 1 comprises a housing 10 and a locking member 11. The locking member 11 is rotatably connected to the housing 10 and can be rotated between a locking position engaged with the mating housing 20 and an unlocking position separated from the mating housing 20. The locking member 11 includes a pair of force arms 110, a pair of hook shaped locking parts 111, and a pair of rollers 112. One ends (lower ends in the figure) of the pair of force arms 110 are rotatably connected to the outer side of the housing 10. The pair of hook shaped locking parts 111 are respectively formed on the other ends (upper ends in the figure) of the pair of force arms 110. The pair of rollers 112 are respectively rotatably installed on the ends of the pair of hook shaped locking parts 111.

When the locking member 11 is rotated to the locking position, the hook shaped locking part 111 of the locking member 11 is locked onto the locking post 21 of the mating housing 20 to lock the housing 10 and the mating housing 20 together. During the process of locking the hook shaped locking part 111 to the locking post 21, the roller 112 on the hook shaped locking part 111 is in rolling contact with the locking post 21 to reduce friction between the two. Therefore, the embodiments of the present disclosure can extend the service life of the locking member 11 and the locking post 21, and ensure that the connector 1 and the mating connector 2 are firmly locked in the mating state.

In the illustrated embodiments, the locking member 11 further comprises a pair of connecting shafts 113, which are respectively fixed to the ends of the pair of hook shaped locking parts 111. The pair of rollers 112 are respectively rotatably on the pair of connecting shafts 113. A connecting hole 111a is formed in the end of the hook shaped locking part 111. The connecting shaft 113 includes: a first shaft portion 113a and a second shaft portion 113b. The first shaft portion 113a is located at one end of the connecting shaft 113 and is fixed into the connecting hole 111a. One end of the second shaft portion 113b is connected to the first shaft portion 113a and its diameter is larger than that of the first shaft portion 113a. The roller 112 is rotatably installed on the second shaft portion 113b.

The first shaft portion 113a is riveted to the connecting hole 111a on the hook shaped locking part 111. However, the present invention is not limited to the illustrated embodiments. For example, the first shaft portion 113a can also be welded to the connecting hole 111a on the hook shaped locking part 111.

The pair of hook shaped locking parts 111 have inner sides facing each other and outer sides opposite to each other. The second shaft portion 113b protrudes from the outer side of the hook shaped locking part 111. In this way, the roller 112 installed on the second shaft portion 113b is located on the outer side of the hook shaped locking part 111.

The connecting shaft 113 further includes a limiting flange 113c, which is formed on the other end of the second shaft portion 113b and protrudes radially. The roller 112 is axially limited between the limit flange 113c and the outer end of the hook shaped locking part 111 to ensure that the roller 112 cannot be detached axially from the connecting shaft 113.

A pivot hole 110a is formed in one end of the force arm 110, and a support shaft 12 is fixed on the outer side of the housing 10. The support shaft 12 is rotatably fitted in the pivot hole 110a, allowing the locking member 11 to rotate around the support shaft 12 between the locking and unlocking positions. The support shaft 12 is riveted or welded to the housing 10. In the illustrated embodiment, the axis of the supporting shaft 12 is parallel to the axis of the connecting shaft 113.

The locking member 11 further includes a connecting arm 114, which is connected between the other ends of the pair of force arms 110 to ensure synchronous rotation of the pair of force arms 110. The locking member 11 further includes a handle part 115, which is connected to the connecting arm 114. Therefore, an operator is able to drive the locking member 11 to rotate between the locking position and the unlocking position by operating the handle part 115.

The pair of force arms 110, the pair of hook shaped locking parts 111, the connecting arm 114, and the handle part 115 are formed into an integral piece. The connector further comprises an insulator and a terminal. The insulator is installed in the housing 10. The terminal is provided in the insulator.

Still referring to FIGS. 1-6, in another exemplary embodiment of the present disclosure, a connector assembly is also provided. The connector assembly includes the above connector 1 and a mating connector 2. The mating connector 2 is mated with the connector 1. The mating connector 2 includes a mating housing 20 and a locking post 21. The mating housing 20 is adapted to mate with the housing 10 of the connector 1. The locking post 21 is fixed on the outer side of the mating housing 20. The hook shaped locking part 111 of the locking member 11 of connector 1 is locked onto the locking post 21 of the mating housing 20, in order to lock the connector 1 and the mating connector 2 in the mating state. During the process of locking the hook shaped locking part 111 to the locking post 21, the roller 112 on the hook shaped locking part 111 is in rolling contact with the locking post 21 to reduce friction between the two. The locking post 21 is riveted or welded to the mating housing 20.

In the illustrated embodiments, the mating connector 2 further comprises a mating insulator and a mating terminal. The mating insulator is provided in the mating housing 20 for mating with the insulator of the connector 1. The mating terminal is provided in the mating insulator for mating with the terminal of the connector 1.

### Second Embodiment

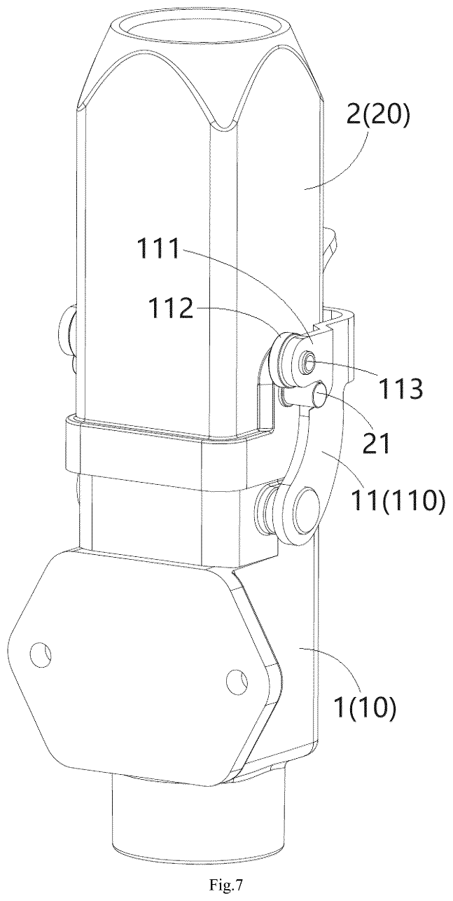

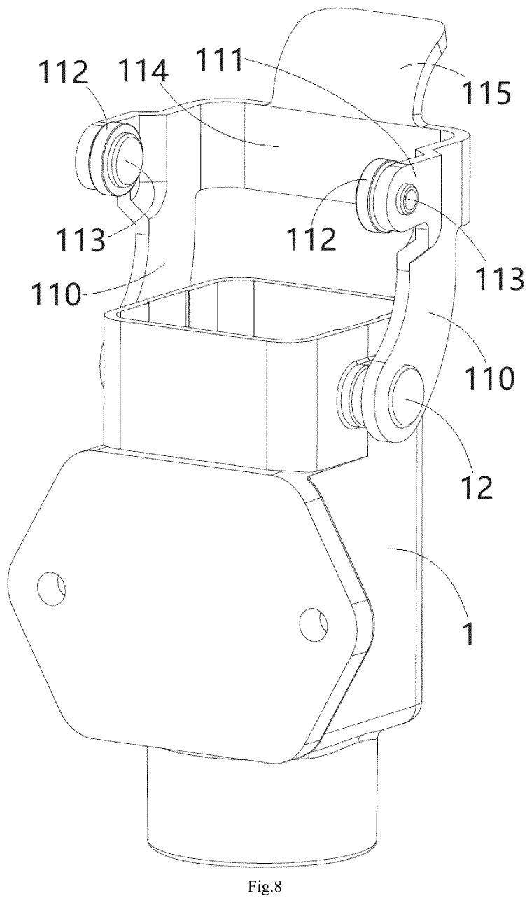

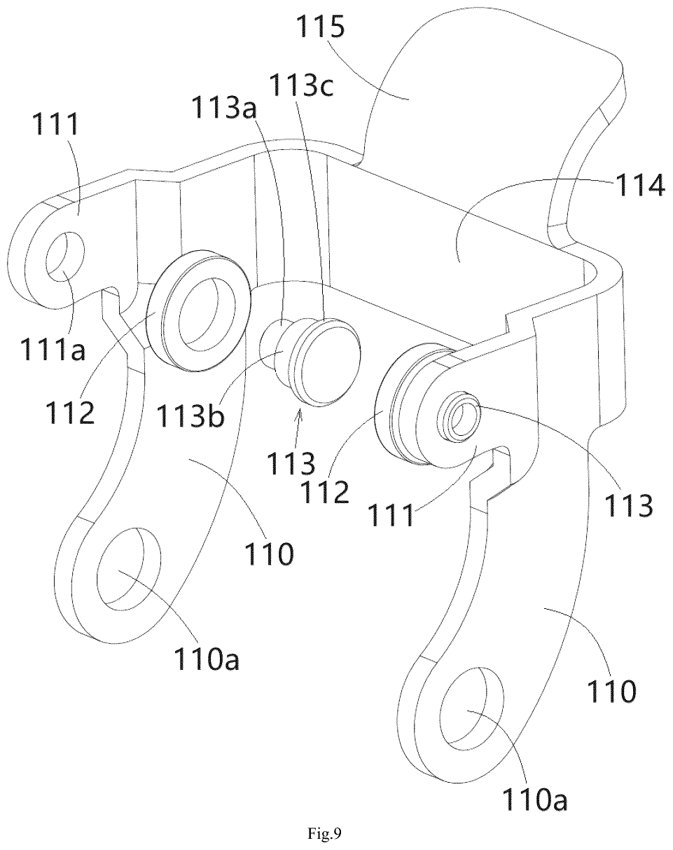

FIGS. 7-9 show connectors and a connector assembly according to a second embodiment of the present disclosure. Specifically, FIG. 7 shows an illustrative perspective view of a connector assembly according to another exemplary embodiment of the present invention. FIG. 8 shows an illustrative perspective view of connector 1 according to another exemplary embodiment of the present invention. FIG. 9 shows an illustrative perspective view of the locking member 11 of connector 1 according to another exemplary embodiment of the present invention.

As shown in FIGS. 7-9, in an exemplary embodiment of the present disclosure, a connector 1 is provided. The connector 1 comprises a housing 10 and a locking member 11. The locking member 11 is rotatably connected to the housing 10 and can be rotated between a locking position engaged with the mating housing 20 and an unlocking position separated from the mating housing 20. The locking member 11 includes a pair of force arms 110, a pair of hook shaped locking parts 111, and a pair of rollers 112. One ends (lower ends in the figure) of the pair of force arms 110 are rotatably connected to the outer side of the housing 10. The pair of hook shaped locking parts 111 are respectively formed on the other ends (upper ends in the figure) of the pair of force arms 110. The pair of rollers 112 are respectively rotatably installed on the ends of the pair of hook shaped locking parts 111.

In the illustrated embodiments, when the locking member 11 is rotated to the locking position, the hook shaped locking part 111 of the locking member 11 is locked onto the locking post 21 of the mating housing 20 to lock the housing 10 and the mating housing 20 together. During the process of locking the hook shaped locking part 111 to the locking post 21, the roller 112 on the hook shaped locking part 111 is in rolling contact with the locking post 21 to reduce friction between the two. Therefore, the embodiments of the present disclosure can extend the service life of the locking member 11 and the locking post 21, and ensure that the connector 1 and the mating connector 2 are firmly locked in the mating state.

The locking member 11 further comprises a pair of connecting shafts 113. The connecting shafts 113 are respectively fixed to the ends of the pair of hook shaped locking parts 111. The pair of rollers 112 are respectively rotatably installed on the pair of connecting shafts 113.

A connecting hole 111a is formed in the end of the hook shaped locking part 111. The connecting shaft 113 includes a first shaft portion 113a and a second shaft portion 113b. The first shaft portion 113a is located at one end of the connecting shaft 113 and is fixed into the connecting hole 111a. One end of the second shaft portion 113b is connected to the first shaft portion 113a and its diameter is larger than that of the first shaft portion 113a. The roller 112 is rotatably installed on the second shaft portion 113b. The first shaft portion 113a is riveted to the connecting hole 111a on the hook shaped locking part 111. However, the present disclosure is not limited to the illustrated embodiments. For example, the first shaft portion 113a can also be welded to the connecting hole 111a on the hook shaped locking part 111.

The pair of hook shaped locking parts 111 have inner sides facing each other and outer sides opposite to each other. The second shaft portion 113b protrudes from the inner side of the hook shaped locking part 111. In this way, the roller 112 installed on the second shaft portion 113b is located on the inner side of the hook shaped locking part 111.

The connecting shaft 113 further includes a limiting flange 113c formed on the other end of the second shaft portion 113b and protruding radially. The roller 112 is axially limited between the limit flange 113c and the inner side of the end of the hook locking part 111. This ensures that the roller 112 cannot be detached axially from the connecting shaft 113.

A pivot hole 110a is formed in one end of the force arm 110, and a support shaft 12 is fixed on the outer side of the housing 10. The support shaft 12 is rotatably fitted in the pivot hole 110a, allowing the locking member 11 to rotate around the support shaft 12 between the locking and unlocking positions. The support shaft 12 is riveted or welded to the housing 10. The axis of the supporting shaft 12 is parallel to the axis of the connecting shaft 113.

The locking member 11 further includes a connecting arm 114 connected between the other ends of the pair of force arms 110 to ensure synchronous rotation of the pair of force arms 110. The locking member 11 further includes a handle part 115 connected to the connecting arm 114. Therefore, the operator is able to drive the locking member 11 to rotate between the locking position and the unlocking position by operating the handle part 115. The pair of force arms 110, the pair of hook shaped locking parts 111, the connecting arm 114 and the handle part 115 are formed into an integral piece. The connector further comprises an insulator and a terminal. The insulator is installed in the housing 10. The terminal is provided in the insulator.

Still referring to FIGS. 7-9, in another exemplary embodiment of the present disclosure, a connector assembly is also provided. This connector assembly includes the above connector 1 and a mating connector 2. The mating connector 2 is mated with the connector 1. The mating connector 2 includes a mating housing 20 and a locking post 21. The mating housing 20 is adapted to mate with the housing 10 of connector 1. The locking post 21 is fixed on the outer side of the mating housing 20. The hook shaped locking part 111 of the locking member 11 of connector 1 is locked onto the locking post 21 of the mating housing 20, in order to lock the connector 1 and the mating connector 2 in the mating state. During the process of locking the hook shaped locking part 111 to the locking post 21, the roller 112 on the hook shaped locking part 111 is in rolling contact with the locking post 21 to reduce friction between the two. In the illustrated embodiments, the locking post 21 is riveted or welded to the mating housing 20.

The mating connector 2 further comprises a mating insulator and a mating terminal. The mating insulator is provided in the mating housing 20 for mating with the insulator of connector 1. The mating terminal is provided in the mating insulator for mating with the terminal of connector 1.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a housing; and
a locking member rotatably connected to the housing and rotatable between a locking position adapted to engage with a mating housing and an unlocking position adapted to be separated from the mating housing, the locking member including:
a pair of force arms, first ends of which are rotatably connected to an outer side of the housing;
a pair of hook shaped locking parts respectively formed on second ends of the pair of force arms, when the locking member is rotated to the locking position, the hook shaped locking part of the locking member is adapted to be locked onto a locking post of the mating housing to lock the housing and the mating housing together; and
a pair of rollers rotatably installed on the ends of the hook shaped locking parts, respectively, as the hook shaped locking part is locked onto the locking post, the roller of the hook shaped locking part is adapted to be in rolling contact with the locking post.

2. The connector according to claim 1, wherein the locking member further comprises a pair of connecting shafts respectively fixed to the ends of the pair of hook shaped locking parts, the pair of rollers are respectively rotatably installed on the pair of connecting shafts.

3. The connector according to claim 2, wherein:
a connecting hole is formed in the end of the hook shaped locking part; and
the connecting shaft comprises:
a first shaft portion located at one end of the connecting shaft and fixed into the connecting hole; and
a second shaft portion having one end connected to the first shaft portion and having a diameter is larger than that of the first shaft portion, the roller is rotatably installed on the second shaft portion.

4. The connector according to claim 3, wherein the first shaft portion is riveted or welded into the connecting hole on the hook shaped locking part.

5. The connector according to claim 3, wherein the pair of hook shaped locking parts have inner sides facing each other and outer sides opposite to each other, and the second shaft portion protrudes from the outer side of the hook shaped locking part, such that the roller installed on the second shaft portion is located on the outer side of the hook shaped locking part.

6. The connector according to claim 5, wherein the connecting shaft further includes a limiting flange formed on the other end of the second shaft portion and protrudes radially, the roller is axially limited between the limit flange and the outer end of the hook shaped locking part.

7. The connector according to claim 3, wherein the pair of hook shaped locking parts have inner sides facing each other and outer sides opposite to each other, and the second shaft portion protrudes from the inner side of the hook shaped locking part.

8. The connector according to claim 7, wherein the connecting shaft further includes a limiting flange formed on the other end of the second shaft portion and protrudes radially, the roller is axially limited between the limit flange and the inner side of the end of the hook shaped locking part.

9. The connector according to claim 2, wherein a pivot hole is formed in one end of the force arm, and a support shaft is fixed on the outer side of the housing, the support shaft is rotatably fitted in the pivot hole such that the locking member is rotatable around the support shaft between the locking position and the unlocking position.

10. The connector according to claim 9, wherein the supporting shaft is riveted or welded to the housing.

11. The connector according to claim 9, wherein an axis of the supporting shaft is parallel to an axis of the connecting shaft.

12. The connector according to claim 1, wherein the locking member further includes a connecting arm connected between the other ends of the pair of force arms to ensure synchronous rotation of the pair of force arms.

13. The connector according to claim 12, wherein the locking member further includes a handle part connected to the connecting arm and adapted to drive the locking member to rotate between the locking position and the unlocking position.

14. The connector according to claim 13, wherein the pair of force arms, the pair of hook shaped locking parts, the connecting arm and the handle part are formed as an integral piece.

15. The connector according to claim 1, further comprising:
an insulator arranged in the housing; and
a terminal arranged in the insulator.

16. A connector assembly, comprising:
a connector, including:
a housing; and
a locking member rotatably connected to the housing and rotatable between a locking position engaged with a mating housing and an unlocking position separated from the mating housing, the locking member including:
a pair of force arms, first ends of which are rotatably connected to an outer side of the housing; and
a pair of hook shaped locking parts respectively formed on second ends of the pair of force arms; and
a mating connector mated with the connector, including:
a mating housing for mating with the housing of the connector; and
a locking post fixedly on the outer side of the mating housing, the hook shaped locking part of the locking member of the connector is locked onto the locking post of the mating housing and locking the connector and the mating connector in a mating state.

17. The connector assembly according to claim 16, wherein the locking member further includes a pair of rollers rotatably installed on the ends of the hook shaped locking parts, respectively, as the hook shaped locking part is locked onto the locking post, the roller on the hook shaped locking part is in rolling contact with the locking post.

18. The connector assembly according to claim 17, wherein the locking member further includes a pair of connecting shafts respectively fixed to the ends of the pair of hook shaped locking parts, the pair of rollers are respectively rotatably installed on the pair of connecting shafts.

19. The connector assembly according to claim 16, wherein the locking post is riveted or welded to the mating housing.

20. The connector assembly according to claim 16, wherein the mating connector further comprises:
a mating insulator arranged in the mating housing for mating with the insulator of the connector; and
a mating terminal arranged in the mating insulator for mating with the terminal of the connector.
